(19) United States
(12) Patent Application Publication
(10) Pub. No.: US 2014/0250272 A1
(43) Pub. Date: Sep. 4, 2014

(54) SYSTEM AND METHOD FOR FETCHING DATA DURING READS IN A DATA STORAGE DEVICE

(71) Applicant: KABUSHIKI KAISHA TOSHIBA, Tokyo (JP)

(72) Inventors: Andre HALL, Fremont, CA (US); Richard M. EHRLICH, Saratoga, CA (US); Annie Mylang LE, San Jose, CA (US)

(73) Assignee: KABUSHIKI KAISHA TOSHIBA, Tokyo (JP)

(21) Appl. No.: 13/784,432

(22) Filed: Mar. 4, 2013

(51) Int. Cl. G06F 12/08

(52) U.S. Cl. CPC G06F 12/0802
USPC 711/118

(57) ABSTRACT

A controller for a data storage device that includes a cache memory and a non-volatile solid state memory is configured to fetch data from the non-volatile solid state memory in response to a read command, conditionally fetch additional data from the non-volatile solid state memory in response to the read command, and then store some or all of the fetched data in the cache memory. The condition for additional data fetch is met when it is determined that a sequence of N (where N is two or more) most recent read commands is requesting data from a successively increasing and consecutive address range. The additional data fetch speeds up subsequent reads, especially when the requested data sizes are relatively small. When the requested data sizes are larger, improvements in read speeds can be achieved if the time between the large reads are well spaced.

### BACKGROUND

Solid state drives (SSDs) include non-volatile solid-state (e.g., flash) memory for persistently storing data of a connected host computer and provide higher performance than traditional hard disk drives (HDDs) that rely on rotating magnetic disks. A large per gigabyte cost differential still exists between SSDs and hard disk drives, and so hybrid drives have become more popular. Hybrid drives include one or more rotating magnetic disks combined with a smaller size non-volatile solid-state memory than typically found in SSDs. Generally, a hybrid drive provides both the capacity of a conventional HDD and the ability to access data as quickly as an SSD, and for this reason hybrid drives are expected to be more common in portable computing devices such as laptop computers.

A volatile solid state memory, e.g., dynamic random access memory (DRAM), is generally configured in all types of data storage devices, e.g., HDDs, SSD, and hybrid drives, as a cache to speed up reads and writes. During reads, when a host issues a read command, the drive's controller reads the data from magnetic disk or flash memory and returns it to the host. The controller may also store a copy of the returned data in the DRAM so that if a subsequent read command requests the same data, it can return the requested data from the DRAM instead of the magnetic disk or flash memory to speed up the read operation.

### SUMMARY

One or more embodiments provide a data fetching technique in response to read commands received from the host that further speeds up the read operation. According to this technique, a controller for a data storage device, in response to a read command, fetches from the flash memory more data than was requested in the read command, and stores some or all of the fetched data in the cache memory to speed up subsequent reads. The additional data is conditionally fetched, and the condition for the additional data fetch is met when it is determined that a sequence of N (where N is two or more) most recent read commands is requesting data from addresses that are successively increasing.

A method of fetching data in a data storage device including a non-volatile solid state memory and a cache memory having a smaller size than the non-volatile solid state memory, according to an embodiment, includes receiving a read command to fetch data from the non-volatile solid state memory, determining that a condition for additional data fetch has been met, and fetching the data requested by the read command and the additional data from the non-volatile solid state memory and storing at least the additional data in the cache memory.

A data storage device according to an embodiment includes a non-volatile solid state memory, a cache memory having a smaller size than the non-volatile solid state memory, and a controller configured to receive a read command to fetch data from the non-volatile solid state memory, determine that a condition for additional data fetch has been met, fetch the data requested by the read command and the additional data from the non-volatile solid state memory, and store at least the additional data in the cache memory.

A data storage device according to another embodiment includes a first, non-volatile solid state, memory, a second, volatile solid state, memory, and a controller configured to maintain a mapping data structure for the first memory and a cache data structure for a portion of the second memory that has a size which is orders of magnitude smaller than a size of the first memory. The controller of this embodiment is configured to fetch data from the first memory in response to a read command and conditionally fetch additional data from the first memory in response to the read command, and then store at least the additional data in the portion of the second memory.

### BRIEF DESCRIPTION OF THE DRAWINGS

So that the manner in which the above recited features of the embodiments can be understood in detail, a more particular description of the embodiments, briefly summarized above, may be had by reference to the appended drawings. It is to be noted, however, that the appended drawings illustrate only typical embodiments and are therefore not to be considered limiting of its scope, for there may be other equally effective embodiments.

FIG. 1 is a schematic view of a hybrid drive according to an embodiment.

FIG. 2 is a block diagram of the hybrid drive of FIG. 1 with electronic circuit elements configured according to the embodiment.

FIGS. 3A and 3B are schematic diagrams showing operation examples of a controller of the hybrid drive of FIG. 1 configured with and without a command queue.

FIG. 4 is a flowchart of method steps that are carried out during execution of a read operation.

FIG. 5 is a flowchart that details a method for determining whether additional data fetch should be carried out during the read operation.

### DETAILED DESCRIPTION

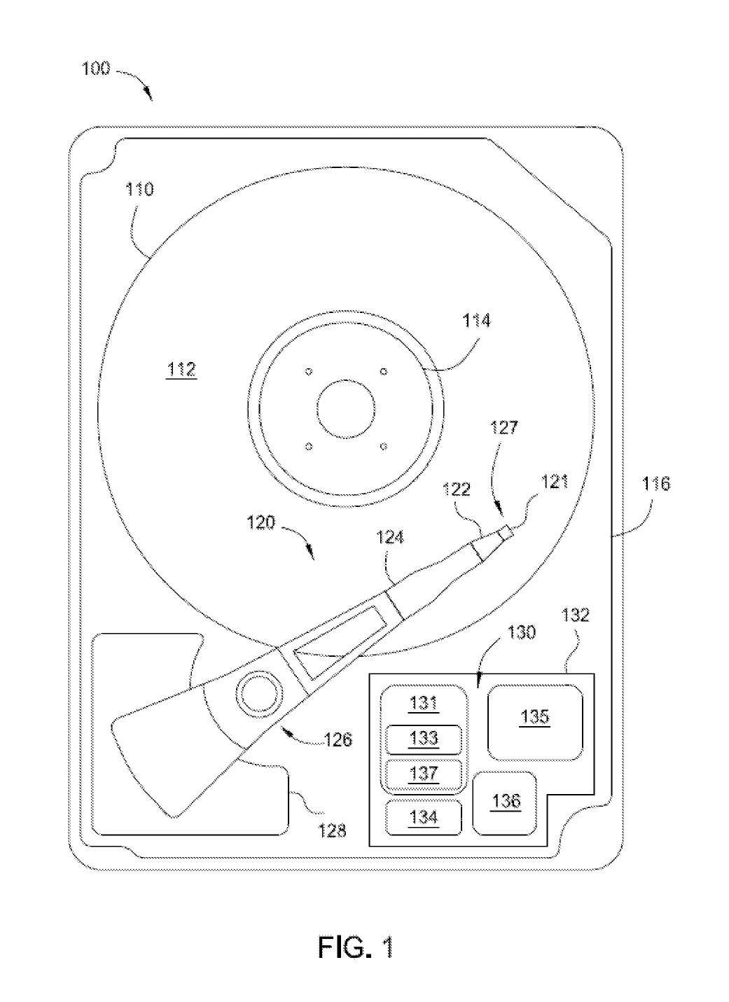

FIG. 1 is a schematic view of an exemplary hybrid drive according to an embodiment. For clarity, hybrid drive 100 is illustrated without a top cover. Hybrid drive 100 includes at least one storage disk 110 that is rotated by a spindle motor 114 and includes a plurality of concentric data storage tracks. Spindle motor 114 is mounted on a base plate 116. An actuator arm assembly 120 is also mounted on base plate 116, and has a slider 121 mounted on a flexure arm 122 with a read/write head 127 that reads data from and writes data to the data storage tracks. Flexure arm 122 is attached to an actuator arm 124 that rotates about a bearing assembly 126. Voice coil motor 128 moves slider 121 relative to storage disk 110, thereby positioning read/write head 127 over the desired concentric data storage track disposed on the surface 112 of storage disk 110. Spindle motor 114, read/write head 127, and voice coil motor 128 are coupled to electronic circuits 130, which are mounted on a printed circuit board 132. Electronic circuits 130 include a read channel 137, a microprocessor-based controller 133, random-access memory (RAM) 134 (which may be a dynamic RAM and is used as a data buffer), and/or a flash memory device 135 and flash manager device 136. In some embodiments, read channel 137 and microprocessor-based controller 133 are included in a single chip, such as a system-on-chip 131. In some embodiments, hybrid drive 100 may further include a motor-driver chip for driving spindle motor 114 and voice coil motor 128. In addition, other non-volatile solid state memory may be used in place of flash memory device 135.

For clarity, hybrid drive 100 is illustrated with a single storage disk 110 and a single actuator arm assembly 120. Hybrid drive 100 may also include multiple storage disks and multiple actuator arm assemblies. In addition, each side of storage disk 110 may have an associated read/write head coupled to a flexure arm.

In normal operation of hybrid drive 100, data can be stored to and retrieved from storage disk 110 and/or flash memory device 135. In hybrid drive 100, non-volatile memory, such as flash memory device 135, supplements the spinning storage disk 110 to provide faster boot, hibernate, resume and other data read-write operations, as well as lower power consumption. Such a hybrid drive configuration is particularly advantageous for battery operated computer systems, such as mobile computers or other mobile computing devices. In a preferred embodiment, flash memory device is a non-volatile solid state storage medium, such as a NAND flash chip that can be electrically erased and reprogrammed, and is sized to supplement storage disk 110 in hybrid drive 100 as a non-volatile storage medium. For example, in some embodiments, flash memory device 135 has data storage capacity that is orders of magnitude larger than RAM 134, e.g., gigabytes (GB) vs. megabytes (MB).

It should be recognized that embodiments may be carried out in any data storage device that employs a non-volatile solid state storage medium for persistent storage and a smaller solid state storage medium, such as a DRAM, for caching purposes. Therefore, embodiments are also applicable to SSDs.

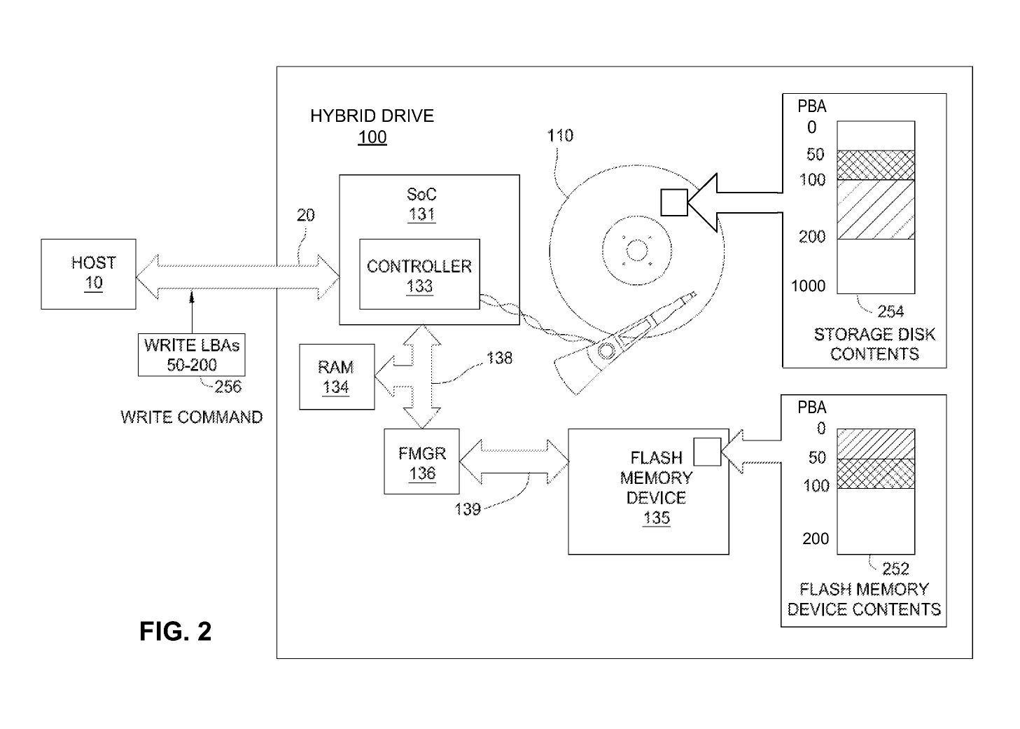

FIG. 2 is a block diagram of hybrid drive 100 with elements of electronic circuits 130 configured according to the embodiment. As shown, hybrid drive 100 includes RAM 134, flash memory device 135, a flash manager device 136, system-on-chip 131, and a high-speed data path 138. Hybrid drive 100 is connected to a host 10, such as a host computer, via a host interface 20, such as a serial advanced technology attachment (SATA) bus.

In the embodiment illustrated in FIG. 2, flash manager device 136 controls interfacing of flash memory device 135 with high-speed data path 138 and is connected to flash memory device 135 via a NAND interface bus 139. System-on-chip 131 includes microprocessor-based controller 133 and other hardware (including a read channel) for controlling operation of hybrid drive 100, and is connected to RAM 134 and flash manager device 136 via high-speed data path 138. Microprocessor-based controller 133 is a control unit that may include a microcontroller such as an ARM microprocessor, a hybrid drive controller, and any control circuitry within hybrid drive 100. High-speed data path 138 is a high-speed bus known in the art, such as a double data rate (DDR) bus, a DDR2 bus, a DDR3 bus, or the like.

Controller 133 employs a portion of RAM 134 as a cache to speed up reads and writes. When host 10 issues a read command (e.g., command 256), controller 133 reads the data from storage disk 110 (e.g., from among storage disk contents 254) or flash memory device 135 (e.g., from among flash memory device contents 252) or from RAM 134 and returns it to host 10. If the controller 133 did not get the data from the cache provisioned in RAM 134, it may also store a copy of the returned data in the cache provisioned in RAM 134 so that if a subsequent read command requests the same data, it can return the requested data from the cache instead of storage disk 110 or flash memory device 135 to speed up the read operation. When host 10 issues a write command (e.g., command 256), controller 133 may store a copy of the write data in the cache in addition to storing them in storage disk 110 (e.g., to become part of storage disk contents 254) or flash memory device 135 (e.g., to become part of flash memory device contents 252), so that if a subsequent read command requests the same data, it can return the requested data from the cache instead of storage disk 110 or flash memory device 135 to speed up the read operation.

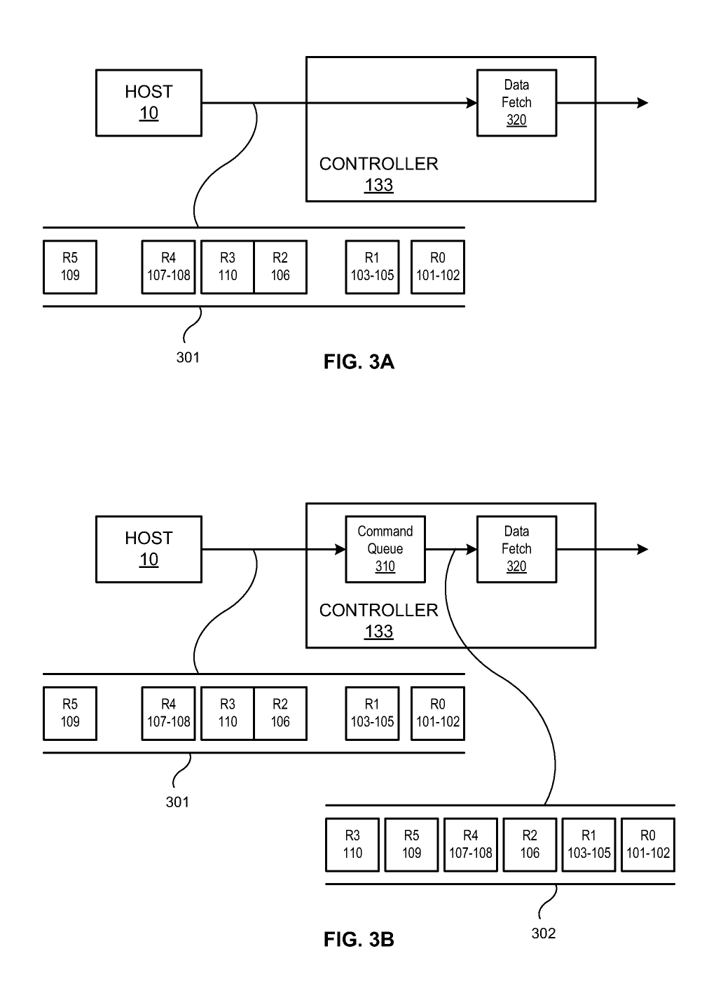

FIGS. 3A and 3B are schematic diagrams that show controller 133 configured with and without a command queue 310. In general, command queue may include a queue for read commands and a queue for write commands, or there may be a single queue that contains both read and write commands, but for purposes of this description, command queue 310 will be assumed to be a queue for read commands.

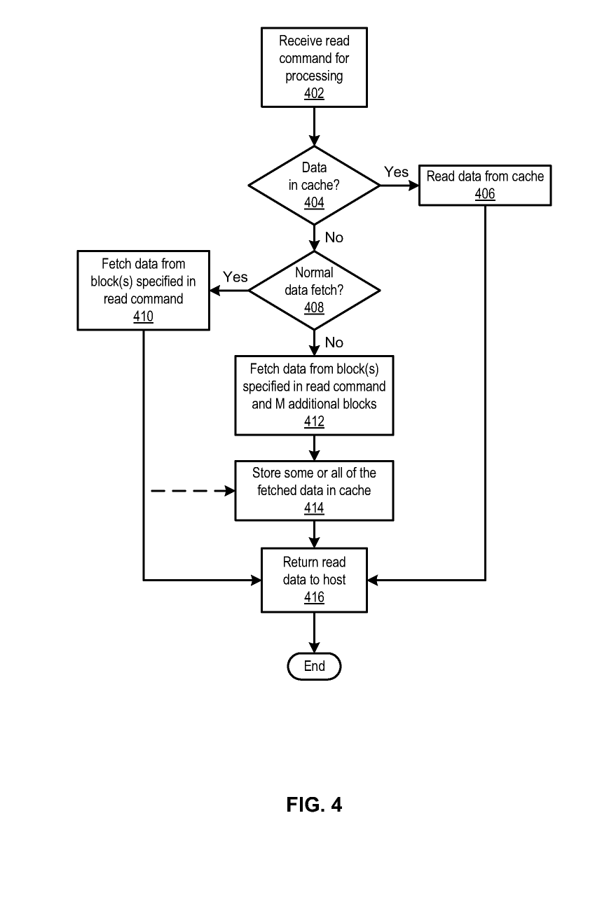

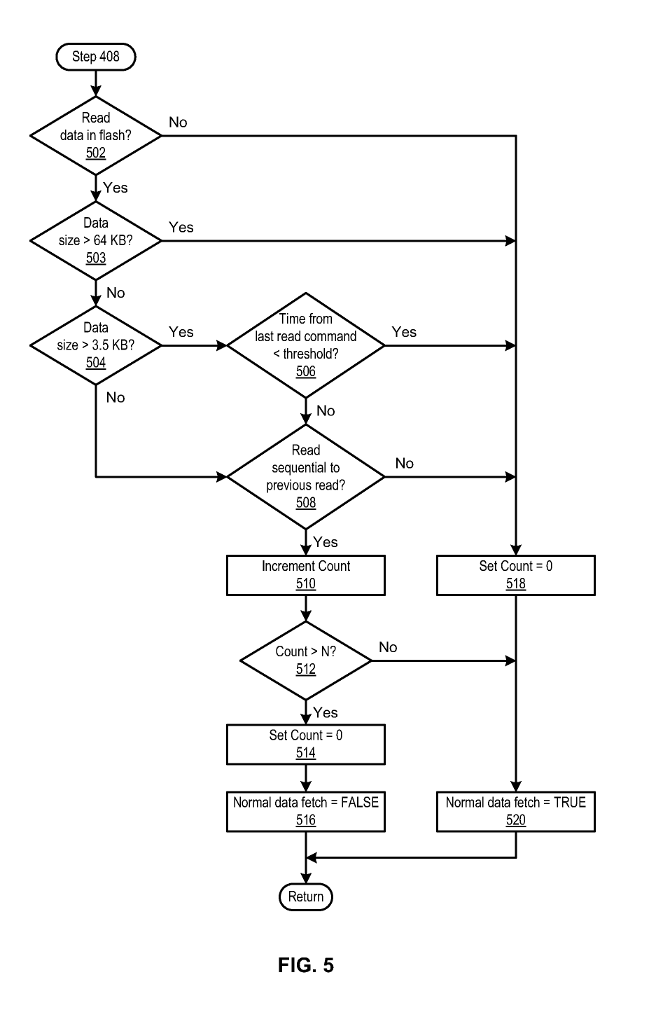

In FIG. 3A, controller 133 is configured without command queue 310 and so read commands 301 from host 10 are streamed in directly into a data fetch module 320 of controller 133 in the order received from host 10. Data fetch module 320 then processes read commands 301 in the order that they are received in the manner that will be described below in conjunction with FIGS. 4 and 5.

By contrast, in FIG. 3B, controller 133 is configured with command queue 310. With this configuration, read commands 301 from host 10 are streamed into command queue 310 first, which reorders them (into reordered read commands 302) before they reach data fetch module 320 of controller 133. Data fetch module 320 then processes reordered read commands 302 in the order that they are received in the manner that will be described below in conjunction with FIGS. 4 and 5.

The reordering that is performed by command queue 310 is with respect to the LBAs corresponding to the read commands. In the example shown in FIGS. 3A and 3B, read commands R0, R1, R2, R3, R4, and R5 are received in that order from host 10, and the LBAs corresponding to these read commands are shown as 101-102 (representing addresses of two data blocks), 103-105 (representing addresses of three data blocks), 106, 110, 107-108, and 109, respectively. Command queue 310 issues read commands R0, R1, and R2 in the order they are received from host 10 because the LBAs corresponding to these read commands are already ordered. However, read command R3 is out of order and thus command queue 310 issues read command R3 after issuing read commands R4 and R5.

Embodiments may be practiced with or without command queue 310. In addition, embodiments that implement command queue 310 are not limited to any particular configuration or size of command queue 310 so long as it performs the reordering in the manner described above.

FIG. 4 is a flowchart of method steps that are carried out during execution of a read operation according to the embodiment. In the embodiment described herein, data fetch module 320 of controller 133 is performing these steps.

This method begins at step 402 with data fetch module 320 receiving a read command for processing. The read command may be received directly from host 10 as shown in FIG. 3A or from command queue 310 as shown in FIG. 3B. At step 404, data fetch module 320 determines whether the read data targeted by the read command is cached (i.e., stored in the cache provisioned in RAM 134). If the read data is cached, it is read from the cache at step 406 and returned to host 10 at step 416. The method terminates thereafter.

If, on the other hand, data fetch module 320 determines at step 404 that the read data targeted by the read command is not cached, it executes decision block 408 to determine whether the fetching of the read data should be carried out normally or not. If normally, data fetch module 320 fetches data from one or more LBAs specified in the read command at step 410, and returns the fetched data to host 10 at step 416. In the embodiments described herein, normal data fetching would occur under any of the following conditions: (1) data is not stored in flash memory device 135; (2) the read command is out of order with respect to the most recent read command processed; and (3) the size of the requested read data is too large and not enough time has elapsed since the most recent read command was processed. In some embodiments, a copy of the data fetched at step 410 may be stored in the cache at step 414 (as indicated by the dashed arrow).

If data fetch module 320 determines at decision block 408 that data fetching should not be normally done, step 412 is executed. At step 412, data fetch module 320 fetches data from one or more LBAs specified in the read command at step 410, and also fetches data from M additional LBAs that follow the LBAs specified in the read command. M is a configurable value that is one or more, more typically around 128. Then, some or all of the data fetched at step 412 is stored in the cache at step 414 and returned to host 10 at step 416. In one embodiment, only the data fetched from the M additional LBAs are stored in the cache at step 414. In other embodiments, both the data fetched from the one or more LBAs specified in the read command and the data fetched from M additional LBAs are stored in the cache at step 414. The conditions for additional data fetching are as follows: (1) if a sequential stream of read commands request small chunks of data (e.g., no larger than 3.5 KB) from consecutive LBAs (or in some embodiments, increasing LBAs) of flash memory device 135; or (2) if the sequential stream of read commands request larger chunks of data (e.g., 3.5 KB to 64 KB) from consecutive LBAs (or in some embodiments, increasing LBAs) of flash memory device 135 and sufficient time has elapsed (e.g., 3 milliseconds) between the read commands. Faster reads are achieved under condition (1) because frequent reads out of flash memory device 135 are much slower than out of the cache provisioned in RAM 134. Faster reads are achieved under condition (2) because the time between the sequential read commands give data fetch module 320 an opportunity to fetch large chunks of data (e.g., 3.5 KB to 64 KB) into the cache provisioned in RAM 134 without a performance penalty and, once in the cache, the data can be read out of the cache faster than out of flash memory device 135. Condition (2) could be applied to additional situations, for example, with an even higher limit on the size of chunks of data (e.g., 256 KB), if the time between commands is even longer (e.g., 12 milliseconds).

FIG. 5 is a flowchart that details step 408 of FIG. 4, which is carried out by data fetch module 320 of controller 133 to determine whether the additional data fetch should be carried out during the read operation. At the outset, data fetch module 320 at step 502 determines if the requested read data is stored in flash memory device 135. If not, the variable Count, which is configured to count the number of sequential reads, is reset to zero at step 518 and the flag for normal data fetch is set to TRUE at step 520. After step 520, the flow returns to the method of FIG. 4.

Other conditions will result in execution of steps 518 and 520. For example, if the size of the requested read data is too large (e.g., greater than 64 KB) (step 503) or the size of the requested read data is large (e.g., 3.5 KB to 64 KB) (step 504) and the amount of time that has lapsed since the most recently issued read command is less than a predetermined threshold time (e.g., less than 3 milliseconds) (step 506), data fetch module 320 executes step 518 and 520. In addition, if the current read LBA is not sequential with respect to the most recently issued read LBA (step 508), data fetch module 320 executes step 518 and 520. In some embodiments, instead of checking whether or not the read LBA is sequential with respect to the most recently issued read LBA, the check at step 508 may be whether or not the read LBA is ordered with respect to the most recently issued read LBA (i.e., current read LBA>most recently issued read LBA).

On the other hand, if none of the conditions for normal data fetch are met, step 510 is executed where the variable Count is incremented by one or, in some embodiments, by a value proportional to the number of logical blocks addressed by the command. If data fetch module 320 at step 512 determines that the variable Count is greater than N (where N is a configurable parameter greater than or equal to 1), then the condition for additional data fetch is deemed to have been met and steps 514 and 516 are executed. At step 514, the variable Count is reset to zero and, at step 516, the flag for normal data fetch is set to FALSE. By setting this flag to FALSE, data fetch module 320 executes the additional data fetch of step 412 when the flow returns to the method of FIG. 4.

Returning to step 512, if data fetch module 320 at step 512 determines that the variable Count is less than or equal to N, then the condition for additional data fetch is deemed not to have been met yet and so step 520 is executed to set the flag for normal data fetch to TRUE. However, because this condition may be met with the next read command, the variable Count is not reset to zero (in other words, the current Count value is retained).

With the data fetching techniques described above, when a subsequent read command that targets an LBA in flash memory 135 that is next in sequence to an LBA of the most recent prior read command, is issued, the read data can be retrieved from the cache provisioned in RAM 134. The overhead associated with the data look-up in the cache is much lower than the data look-up in flash memory device 135, because the number of entries in the cache look-up tables is several (two or more) orders of magnitude less than the number of entries in the flash look-up tables (typically hundreds versus millions or more). For this reason, the subsequent read command can be processed much more quickly than conventionally.

While the foregoing is directed to embodiments, other and further embodiments may be devised without departing from the basic scope thereof, and the scope thereof is determined by the claims that follow.

We claim:

1. A method of fetching data in a data storage device including a first memory and a second memory, the second memory having a smaller memory capacity than the first memory, comprising:
receiving a read command from outside of the data storage device, the read command including an address of data to be read from the data storage device;
determining that a condition for additional data fetch has been met; and
fetching the data requested by the read command and the additional data from the first memory and storing at least the additional data in the second memory.

2. The method of claim 1, wherein, during said storing, the data requested by the read command is also stored in the second memory.

3. The method of claim 1, wherein the address of the data requested by the read command and an address of the additional data are sequential.

4. The method of claim 1, further comprising:
receiving a next read command; and
fetching the data requested by the next read command from the second memory.

5. The method of claim 1, wherein the condition is met upon determining that a sequence of N (where N is two or more) read commands include addresses that are sequential.

6. The method of claim 1, further comprising:
storing read commands received from outside of the data storage in a command queue; and
issuing the read commands out of the command queue in a manner such that successive read commands issued out of the command queue include addresses that are sequential.

7. The method of claim 1, wherein the condition for additional data fetch accounts for size of data requested in each of most recent read commands.

8. The method of claim 1, wherein the condition for additional data fetch accounts for size of data requested in each of most recent read commands and time intervals between the most recent read commands.

9. The method of claim 1, wherein the data storage device further includes a magnetic storage device.

10. The method of claim 1, wherein the first memory is a non-volatile memory.

11. A data storage device comprising:
a first memory;
a second memory having a smaller memory capacity than the first memory; and
a controller configured to receive a read command from outside of the data storage device, the read command including an address of data to be read from the data storage device, determine that a condition for additional data fetch has been met, fetch the data requested by the read command and the additional data from the first memory, and store at least the additional data in the second memory.

12. The data storage device of claim 11, wherein the controller is configured to store the data requested by the read command in the second memory.

13. The data storage device of claim 11, wherein the address of the data requested by the read command and an address of the additional data are sequential.

14. The data storage device of claim 11, wherein the condition is met upon determining that a sequence of N (where N is two or more) read commands include addresses that are sequential.

15. The data storage device of claim 12, wherein the condition for additional data fetch accounts for size of data requested in each of most recent read commands and time intervals between the most recent read commands.

16. The data storage device of claim 12, further comprising a magnetic storage device, wherein the controller is configured to control reads and writes to the magnetic storage device.

17. A data storage device comprising:
a first, non-volatile solid state, memory;
a second, volatile solid state, memory; and
a controller configured to maintain a mapping data structure for the first memory and a cache data structure for a portion of the second memory that has a size that is orders of magnitude smaller than a size of the first memory,
wherein the controller is configured to fetch data from the first memory in response to a read command, conditionally fetch additional data from the first memory in response to the read command, and then store at least the additional data in the portion of the second memory.

18. The data storage device of claim 17, further comprising a magnetic storage device, wherein the controller is configured to control reads and writes to the magnetic storage device.

19. The data storage device of claim 17, wherein the number of entries in the mapping data structure is greater than the number of entries in the cache data structure by two or more orders of magnitude.

20. The data storage device of claim 17, wherein the condition for additional data fetch is met upon determining that a sequence of N (where N is two or more) most recent read commands is requesting data from a successively increasing and consecutive address range.
